(19) United States
(12) Patent Application Publication
(10) Pub. No.: US 2021/0275993 A1
(43) Pub. Date: Sep. 9, 2021

(54) PROCESS FOR PRODUCING A CATALYST COMPRISING AN INTERMETALLIC COMPOUND AND A CATALYST PRODUCED BY THE PROCESS

(71) Applicants: BASF SE, Ludwigshafen am Rhein (DE); The Regents of the University of California, Oakland, CA (US)

(72) Inventors: Peter LEIDINGER, Ludwigshafen am Rhein (DE); Sven TITLBACH, Heidelberg (DE); Andreas HAAS, Ludwigshafen am Rhein (DE); Stephan A. SCHUNK, Heidelberg (DE); Jacob KANADY, Irvine, CA (US)

(21) Appl. No.: 16/343,282

(22) PCT Filed: Oct. 19, 2017
(86) PCT No.: PCT/EP2017/076756

§ 371 Date: Apr. 18, 2019

(30) Foreign Application Priority Data
Oct. 20, 2016 (EP) 16194816.1

(51) Int. Cl. B01J 23/66; B01J 23/63; B01J 35/10; B01J 37/04; B01J 37/06; B01J 37/16; B01J 37/00; B01J 37/34; B01J 21/18; H01M 4/92; H01M 8/10

(52) U.S. Cl. CPC B01J 23/66; B01J 23/63; B01J 35/1009; B01J 37/04; B01J 37/06; B01J 37/16; H01M 2008/1095; B01J 37/343; B01J 21/18; H01M 4/921; H01M 4/926; H01M 8/10; B01J 37/009

(57) ABSTRACT

The invention relates to aprocess for producing a catalyst comprising an intermetallic com-pound comprisingmixing of a salt comprising a metal selected from the group consisting of Co, Rh, Ir, Ni, Pd, Pt, Cu, Ag, Auand Ru, a salt comprising a metal selected from the group consist-ing of Li, Na, K, Rb, Cs, Be, Mg, Ca, Sr, Ba,Sc, Y, La and the lanthanides, and a reducing agentcomprising a salt,wherein the mixing is carried out at a temperature where all compo-nents are solid; reacting the mixture obtained to form an intermetallic compound by heating said to a temperature in the range between the melting temperature of thereducing agent and the melting temperature of the intermetallic compound and holdingthe temperaturefor1 minute to 600 minutes; and washing the mixture to removeby-products andremainders of the salt of the cations of the reducing agent and at least one of the anions of the salts used in the first step. The invention further relates to a catalyst obtained by the process.

The invention relates to a process for producing a catalyst comprising an intermetallic compound comprising a metal selected from Co, Rh, Ir, Ni, Pd, Pt, Cu, Ag, Au and Ru and a second metal selected from Li, Na, K, Rb, Cs, Be, Mg, Ca, Sr, Ba, Sc, Y, La, and lanthanides. The invention further relates to a catalyst comprising a support and an intermetallic compound, wherein the intermetallic compound is in the form of nanoparticles and deposited on the surface of the support and in macropores, mesopores and micropores of the support.

Platinum-containing catalysts are for example applied in proton exchange membrane fuel cells (PEMFCs). Proton exchange membrane fuel cells are applied for an efficient conversion of stored chemical energy to electric energy. It is expected that future applications of PEMFCs are in particular mobile applications. For electrocatalysts, typically carbon-supported platinum nanoparticles are used. Especially on the cathode of a PEMFC, high amounts of the scarce and expensive metal platinum are required for a sufficient activity in the oxygen reduction reaction. An increased platinum-mass related activity can be realized by alloying platinum with a second metal like cobalt, nickel or copper. Such catalysts are described for example by Z. Liu et al., “Pt Alloy Electrocatalysts for Proton Exchange Membrane Fuel Cells: A Review”, Catalysis Reviews: Science and Engineering, 55 (2013), pages 255 to 288. However, as shown by I. Katsounaros et al., “Oxygen Electrochemistry as a Cornerstone for Sustainable Energy Conversion”, Angew. Chem. Int., Ed. 53 (2014), pages 102 to 121, under fuel cell conditions the second metal leaches out into the electrode. As a consequence, the activity decreases. In addition, the membrane is poisoned by the dissolved metal ions, lowering the overall performance of the PEMFC.

An alloy is a partial or complete solid solution of one or more elements in a metallic matrix. Complete solid solution alloys give single solid phase microstructure, while partial solutions give two or more phases that may be homogeneous in distribution depending on thermal (heat treatment) history. Alloys usually have different properties from those of the component elements. Intermetallic Compound in the present context, the term “intermetallic compound” refers to those alloys which exist as a single ordered phase. Alloys don't necessarily need to be ordered or a single phase.

As very active and stable catalysts for the oxygen reduction reaction, the intermetallic compounds Pt₃Y and Pt₃Sc were identified in theoretical calculations by J. Greeley et al., “Alloys of platinum and early transition metals as oxygen reduction electrocatalysts”, Nature Chemistry, Vol. 1, October 2009, pages 552 to 555. Greeley et al. further verified the promising activity and stability pattern experimentally on model surfaces. A possible process for producing intermetallic compounds of platinum and yttrium is described by P. Hernandez-Fernandez et al., “Mass-selected nanoparticles of PtₓY as model catalysts for oxygen electroreduction”, Nature Chemistry 6 (2014), pages 732 to 738. However, this process that is carried out in the gas phase only allows producing very small amounts. There is no synthesis known for nanoparticles containing an intermetallic compound of Co, Rh, Ir, Ni, Pd, Pt, Cu, Ag, Au or Ru as first metal and Li, Na, K, Rb, Cs, Be, Mg, Ca, Sr, Ba, Sc, Y, La, or lanthanides as second metal which allows production of sufficient amounts for industrial applications and which can be operated economically. It is a further disadvantage of the process as shown by P. Hernandez-Fernandez that it is impossible to place the produced nanoparticles into the macropores and mesopores of a catalyst support. The nanoparticles produced in the gas phase are deposited only on the outer surface of the support.

M. K. Jeon et al., “Carbon supported Pt—Y electrocatalysts for the oxygen reduction reaction”, J. Power Sources 196 (2011), pages 1127 to 1131, describe a process to synthesize a catalyst comprising platinum and yttrium in which NaBH₄ is used as reducing agent and H₂PtCl₆ and Y(NO₃)₃ as metal precursors. In this process, platinum nanoparticles were deposited on a carbon support, following by washing and thermal treatment in a flow of H₂/Ar at a temperature of 900° C. A slight change of the lattice constants according to XRD was taken as indicator for the incorporation of Y in the Pt lattice. However, specific X-ray diffraction peaks of an intermetallic compound of Pt and Y were absent.

A synthetic approach for the synthesis of the intermetallic compounds Pt₃Ti and Pt₃V was shown by Z. Cui et al., “Synthesis of Structurally Ordered Pt₃Ti and Pt₃V Nanoparticles as Methanol Oxidation Catalysts”, Journal of the American Chemical Society 136 (2014), pages 10206 to 10209. As metal precursors the chlorides PtCl₄ and TiCl₄ or VCl₃ and as reducing agent potassium triethylborohydride were used. During reduction in tetrahydrofuran, KCl was formed and precipitated. Due to its insolubility in tetrahydrofuran, it acts as stabilizer against sintering of the nanoparticle intermediates during subsequent thermal treatment at about 700° C.

As Y/Y³⁺ has a negative standard electrode potential (−2.37 V) that is more than 1 V more negative than that of Ti/TiO²⁺ (−0.88 V) or V/V³⁺ (−1.19 V), a reduction of Y to a similar extent as Ti or V seems to be impossible at similar experimental conditions. Further, for the formation of an intermetallic compound with platinum, yttrium, scandium or a lanthanide have to be present in an oxidation state as low as possible in the course of the synthesis. However, the highly negative redox potential of those metals and the high affinity towards oxygen makes the reduction very challenging. Therefore, the formation of an intermetallic phase containing platinum and yttrium, scandium or a lanthanide via a route comparable to that for producing the intermetallic compounds Pt₃Ti or Pt₃V is not expected.

It is an object of the present invention to provide a process for producing a catalyst comprising an intermetallic compound that can be operated in such a way that a sufficient amount of the catalyst for industrial applications can be produced economically. It is a further object of the invention to provide such a catalyst.

This object is achieved by a process for producing a catalyst comprising an intermetallic compound comprising following steps:
(a) Mixing of a salt comprising a metal selected from the group consisting of Co, Rh, Ir, Ni, Pd, Pt, Cu, Ag, Au and Ru, a salt comprising a metal selected from the group consisting of Li, Na, K, Rb, Cs, Be, Mg, Ca, Sr, Ba, Sc, Y, La and the lanthanides, and a reducing agent comprising a salt, wherein the mixing is carried out at a temperature where all components are solid;
(b) Reacting the mixture obtained in step (a) to form an intermetallic compound by heating said mixture to a temperature in the range between the melting temperature of the reducing agent and the melting temperature of the intermetallic compound and holding the temperature for 1 minute to 600 minutes;
(c) Optionally washing the mixture obtained in step (b) once or repeatedly with one or more aprotic solvents or combinations of aprotic solvents, whereby a salt of the cation of the reducing agent and at least one of the anions of the salts used in step (a) does not dissolve in said solvent followed by heating the mixture obtained after washing to a temperature in the range between the melting temperature of the reducing agent and the melting temperature of the intermetallic compound and holding the temperature for 1 minute to 600 minutes, wherein the washing and heating can be carried out repeatedly;
(d) Washing the mixture obtained in step (b) or (c) to remove by-products and remainders of the salt of the cations of the reducing agent and at least one of the anions of the salts used in step (a).

In contrast to the known processes for producing intermetallic compounds which either only allow to produce very small amounts or have a very high energy consumption, the inventive process allows to produce a catalyst comprising an intermetallic compound in an amount sufficient for industrial applications and further with reduced energy consumption and therefore more economically.

In the scope of the present invention the lanthanide is one of cerium, praseodymium, neodymium, promethium, samarium, europium, gadolinium, terbium, dysprosium, holmium, erbium, thulium, ytterbium and lutetium.

As generally supported catalysts are used, it is preferred to add a support in step (a) or during the washing in step (c) or in step (d) to achieve a supported catalyst comprising the support and the intermetallic compound, wherein the intermetallic compound is in the form of nanoparticles and deposited on the surface of the support and in the pores of the support. The pores of the support in which the nanoparticles of the intermetallic compound are deposited are macropores, mesopores and micropores support. In this context macropores are pores having a diameter of more than 50 nm, mesopores are pores having a diameter in the range from 2 to 50 nm and micropores are pores having a diameter of less than 2 nm. The amount of the support that is added preferably is in the range from 10 to 99.9 wt %, more preferably in the range from 20 to 99.5%, and most preferably in the range from 40 to 99% based on the total mass of all solids added in step (a) and the support.

For producing the catalyst in the first step (a) a salt comprising a metal selected from the group consisting of Co, Rh, Ir, Ni, Pd, Pt, Cu, Ag, Au and Ru, a salt comprising a metal selected from the group consisting of Li, Na, K, Rb, Cs, Be, Mg, Ca, Sr, Ba, Sc, Y, La and the lanthanides, and a reducing agent comprising a salt are mixed, wherein the mixing is carried out at a temperature where all components are solid. Preferably the mixing is carried out at room temperature.

The salt comprising a metal selected from the group consisting of Co, Rh, Ir, Ni, Pd, Pt, Cu, Ag, Au and Ru preferably is a platinum salt, a silver salt, a rhodium salt, an iridium salt, a palladium salt or a gold salt. Particularly preferred the salt comprising a metal selected from the group consisting of Co, Rh, Ir, Ni, Pd, Pt, Cu, Ag, Au and Ru is a platinum salt. Further it is preferred that the salt comprising a metal selected from the group consisting of Co, Rh, Ir, Ni, Pd, Pt, Cu, Ag, Au and Ru is a halide and particularly preferred the salt comprising a metal selected from the group consisting of Co, Rh, Ir, Ni, Pd, Pt, Cu, Ag, Au and Ru is a chloride. Thus it is particularly preferred that the salt comprising a metal selected from the group consisting of Co, Rh, Ir, Ni, Pd, Pt, Cu, Ag, Au and Ru is platinum chloride.

The salt comprising a metal selected from the group consisting of Li, Na, K, Rb, Cs, Be, Mg, Ca, Sr, Ba, Sc, Y, La and the lanthanides preferably is a calcium salt, an yttrium salt, a scandium salt or a lanthanum salt. Further, like the salt comprising a metal selected from the group consisting of Co, Rh, Ir, Ni, Pd, Pt, Cu, Ag, Au and Ru, it is preferred that the salt comprising a metal selected from the group consisting of Li, Na, K, Rb, Cs, Be, Mg, Ca, Sr, Ba, Sc, Y, La and the lanthanides is a halide and particularly preferred a chloride.

Suitable reducing agents that can be used in connection with the present invention are for example alkali metal alkylborohydride or alkali metal arylborohydride or a mixture of an alkali metal hydride with an alkylborane or an arylborane. Preferably the reducing agent is selected from the group consisting of alkali metal triethylborohydride, alkali metal tripropylborohydride, alkali metal tributylborohydride, alkali metal hydride with triethylborane, alkali metal hydride with tripropylborane, and alkali metal hydride with tributylborane. Particularly preferred the reducing agent is alkali metal triethylborohydride, alkali metal tripropylborohydride, alkali metal tributylborohydride or alkali metal hydride with tributylborane. The alkali metal in the aforementioned compounds preferably is sodium or potassium and particularly preferred potassium.

The mixing in step (a) can take place in any suitable mixing device. Mixing devices which can be used are for example screw mixers, gas jet mixers, fluidized beds, rotating mixers or mixers with rotating components.

To achieve a good mixture it is preferred that the salt comprising a metal selected from the group consisting of Co, Rh, Ir, Ni, Pd, Pt, Cu, Ag, Au and Ru, the salt comprising a metal selected from the group consisting of Li, Na, K, Rb, Cs, Be, Mg, Ca, Sr, Ba, Sc, Y, La and the lanthanides, and the reducing agent each are pulverized. Further it is preferred, that the D50 diameter of the used powders is in the range from 1 to 500 μm.

In the event that the particles of any of the used components to be mixed are bigger than required, it is also possible to use a combined grinding and mixing process. The grinding and mixing for example can be carried out in a mill, for example a roll mill or a ball mill. In an alternative it is also possible to grind only that compounds having a particle size which is bigger than the required particle size wherein all compounds are ground separately, and to mix the compounds after grinding in a separate process. However, in the event that grinding is necessary it is preferred to use a combined grinding and mixing process which means that all components are fed into the mill and are ground and mixed in the mill.

The mixing and if carried out the grinding can be performed continuously or batchwise.

The amount of the salt comprising a metal selected from the group consisting of Co, Rh, Ir, Ni, Pd, Pt, Cu, Ag, Au and Ru in the mixture achieved in step (a) preferably is in the range from 1 to 70 wt %, more preferred in the range from 2 to 30 wt % and particularly preferred in the range from 3 to 20 wt %, each based on the total mass of the mixture.

The amount of the salt comprising a metal selected from the group consisting of Li, Na, K, Rb, Cs, Be, Mg, Ca, Sr, Ba, Sc, Y, La and the lanthanides in the mixture achieved in step (a) preferably is in the range from 0.5 to 70 wt %, more preferred in the range from 1 to 30 wt % and particularly preferred in the range from 2 to 15 wt %, each based on the total mass of the mixture.

The amount of the reducing agent in the mixture achieved in step (a) preferably is in the range from 10 to 95 wt %, more preferred in the range from 20 to 95 wt % and particularly preferred in the range from 30 to 90 wt %, each based on the total mass of the mixture.

Additionally it is possible to add an aprotic liquid to the solid components in step (a) as a plasticizer or stirring aid, the liquid being selected from the group consisting of alkanes, alkenes, aromatic hydrocarbons, amines, ethers and mixtures thereof, provided that each of said compounds is liquid at 50° C. Particularly preferred, the aprotic liquid which is used as plasticizer or stirring aid is selected from the group consisting of squalane, 1,13-tetradecadiene, 1-octadecene, trioctlyamine, 1,3-diisopropylbenzene and dioctyl ether.

The amount of the aprotic liquid preferably is in the range from 1 to 95 wt %. More preferred, the amount of the aprotic liquid is in the range from 10 to 90 wt % and particularly preferred in the range from 30 to 70 wt %, also each based on the total mass of the mixture achieved in step (a).

Further it is possible to additionally add an inert salt to improve the dispersion of the metal particles. Suitable inert salts are particularly alkali metal halides. The alkali metal of the alkali metal halide preferably is sodium or potassium. The halide of the alkali metal halide preferably is chloride. Particularly preferred the alkali metal halide is sodium chloride or potassium chloride.

After mixing the salt comprising a metal selected from the group consisting of Co, Rh, Ir, Ni, Pd, Pt, Cu, Ag, Au and Ru, the salt comprising a metal selected from the group consisting of Li, Na, K, Rb, Cs, Be, Mg, Ca, Sr, Ba, Sc, Y, La and the lanthanides, the reducing agent and if added the aprotic liquid and the inert salt, the mixture is heated to a temperature in the range between the melting temperature of the reducing agent and the melting temperature of the intermetallic compound and hold the temperature from 1 minute to 600 minutes. Preferably, the mixture is heated to a temperature in the range from 150 to 700° C., particularly from 400 to 700° C. The duration of the heating step preferably is from 1 to 240 min and particularly preferred in the range from 30 to 180 min.

For heating it is either possible to fill the mixture obtained in step (a) into a heated oven or to heat the mixture in a heating device until the preset temperature for the heating step is reached. If the mixture is heated until a preset temperature is reached, the heating is carried out continuously with 0.5 to 20° C./min or stepwise, for example raising the temperature 130 to 250° C., hold the temperature for 2 to 120 min and repeat that until the preset temperature is reached. In a preferred embodiment the mixture is heated to 200° C. with 5 K/min, this temperature is held for 40 min. Furthermore, the temperature is increased to 650° C. with 5 K/min and this temperature is held for 180 min.

During the heating step a reaction takes place in which an intermetallic compound comprising the metal of the salt comprising a metal selected from the group consisting of Co, Rh, Ir, Ni, Pd, Pt, Cu, Ag, Au and Ru and the metal of the salt comprising a metal selected from the group consisting of Li, Na, K, Rb, Cs, Be, Mg, Ca, Sr, Ba, Sc, Y, La and the lanthanides is formed. As it is particularly preferred, that the metal of the salt comprising a metal selected from the group consisting of Co, Rh, Ir, Ni, Pd, Pt, Cu, Ag, Au and Ru is platinum and the metal of the salt comprising a metal selected from the group consisting of Li, Na, K, Rb, Cs, Be, Mg, Ca, Sr, Ba, Sc, Y, La, and lanthanides is calcium, yttrium, scandium or lanthanum, the intermetallic compound preferably comprises platinum and calcium, yttrium, scandium or lanthanum. Particularly preferred, the intermetallic compound is Pt₂Ca, Pt₃Y, Pt₃Sc or Pt₃La.

The intermetallic compound is formed in a chemical reaction. In that reaction the reducing agent and at least one of the salts used in step (a) form a salt of cations of the reducing agent and at least one of the anions of the salts used in step (a). Additionally, further by-products can be formed.

To achieve a higher yield of the intermetallic compound it is possible to optionally wash the mixture after the heating in step (b) once or repeatedly with one ore more aprotic solvent or combinations of aprotic solvents in which the salt of cations of the reducing agent and at least one of the anions of the salt used in step (a) does not dissolve followed by heating the intermediate product to a temperature in the range of the melting temperature of the reducing agent and the melting temperature of the intermetallic compound and hold the temperature 1 minute to 600 minutes. This washing and heating step can be carried out only once or repeatedly. If such a washing step with an aprotic solvent is applied, the thermal treatment in step (b) is typically conducted at a lower temperature in comparison with the temperature treatment in step (c). The temperature of this heating step preferably also is from 400 to 700° C. and the duration in the range from 1 to 240 min. Particularly preferred, the heating step after the washing is carried out by heating the mixture to 650° C. with 5 K/min and this temperature is held for 180 min.

In the washing and heating step (c) the washing can be carried out once or repeatedly before heating. If the washing is conducted repeatedly, it is possible to use the same aprotic solvent or combination of aprotic solvents for each washing step or to use different aprotic solvents or combinations of aprotic solvents in the washing steps. If different aprotic solvents or combinations of aprotic solvents are used it is further possible not to use a different aprotic solvent or combination of aprotic solvents in each washing step but to carry out some of the washing steps by using the same aprotic solvent or combination of aprotic solvents.

The aprotic solvent that is used for washing in step (c) preferably is selected from the group consisting of tetrahydrofuran, dioxanes, ethylene glycol dimethyl ether and diethylene glycol dimethyl ether either alone or in conjunction with a low-boiling alkane from the group consisting of pentane, hexane, and heptane. Particularly preferred, the aprotic solvents used for washing in step (c) are tetrahydrofuran and hexane.

In the context of the present invention, the general description “alkane”, for example “pentane”, “hexane” or “heptane” is used to cover all isomers which comprise the branched and unbranched forms n-alkane and all iso-alkanes having the same number of C-atoms. Thus for example the term “pentane” comprises n-pentane and 2-methyl butane and the term “hexane” comprises n-hexane, 2-methyl pentane, 3-methyl pentane, 2,2-dimethyl butane and 2,3-dimethyl butane.

The washing with the aprotic solvent can be performed by any suitable washing process that is known by a skilled person. Continuous washing processes are as suitable as batchwise processes.

To achieve the intermetallic compound, the salt of cations of the reducing agent and at least one of the anions of the salt used in step (a) and the further by-products have to be removed. This is carried out in final step (d) in which the mixture obtained step (b) or (c) is washed to remove by-products and remainders of the salt of cations of the reducing agent and at least one of the anions of the salts used in step (a).

The final washing in step (d) also can be performed by any suitable continuous or batchwise process. The washing medium preferably is either water or an aqueous solution of an acid. Acids that can be used are for example sulfuric acid, sulfonic acid, methyl sulfonic acid, nitric acid, phosphoric acid, phosphonic acid, hydrochloric acid, carboxylic acids, or perchloric acid. A preferred acid is sulfuric acid.

To reduce the formation of by-products it is preferred to carry out step (a), step (b) and—if per-formed—at least the heating in step (c) in an inert atmosphere. However, besides the heating it is also possible to carry out the washing in step (c) in an inert atmosphere. An inert atmosphere in this context means that no components are contained which may react with any of the components of the intermediate product. Such components are for example oxygen or oxygen containing substances for example water. Preferred as inert atmosphere are nitrogen, argon, hydrogen, methane or any mixture of these gases or vacuum. Particularly preferred as inert atmosphere are nitrogen, argon or vacuum.

For the washing step (d) it is possible but not necessary to use an inert atmosphere. The washing in step (d), therefore, preferably is performed in air. This allows usage of less complex apparatus for the washing.

By the inventive process a catalyst is produced which comprises a support and an intermetallic compound comprising a metal selected from the group consisting of Co, Rh, Ir, Ni, Pd, Pt, Cu, Ag, Au and Ru, and a metal selected from the group consisting of Li, Na, K, Rb, Cs, Be, Mg, Ca, Sr, Ba, Sc, Y, La, and lanthanides, wherein the intermetallic compound is in the form of nanoparticles and is deposited on the surface of the support and in macropores, mesopores and micropores of the support.

In a preferred embodiment, the intermetallic compound comprises platinum and one of Ca, Y, Sc and La. Particularly preferred the intermetallic compound is Pt₂Ca, Pt₃Y, Pt₃Sc or Pt₃La.

The supported catalyst generally has an amount of platinum between 1 and 40 wt-% based on the total mass of the supported catalyst. The nanoparticles of the intermetallic compound preferably have a diameter below 100 nm, more preferred in the range from 1 to 50 nm, preferably in the range from 1 to 30 nm and particularly preferred in the range from 2 to 15 nm.

The support that is used for the catalyst can be any porous support known for use with catalysts. Preferably, a support is used which is porous and has a BET surface of at least 4 m²/g. Preferably, the BET surface is in the range from 20 to 1000 m²/g and particularly preferred in the range from 70 to 300 m²/g.

The material for the support can be a metal oxide or carbon. If a metal oxide is used, the metal oxides generally are ceramics. Suitable metal oxides are for example mixed oxides like antimony tin oxide, aluminum oxide, silicon oxide or titanium oxide. Preferred are ceramics containing more than one metal or mixed oxides. However, carbon supports are preferably preferred. Suitable carbon supports for example are carbon black, activated carbon, graphenes and graphite.

The catalyst preferably can be used as an electrocatalyst, particularly as a cathode catalyst, for fuel cells. Particularly, the catalyst is used in proton exchange membrane fuel cells.

### EXAMPLES

### Example 1

### Pt₃Y

19.6 mg yttrium(III)chloride (YCl₃), 33.7 mg platinum(IV)chloride (PtCl₄) and 442 mg potassium triethylborohydride (KEt₃BH) were mixed as powders. Under stirring, the mixture was heated to 140° C. After 10 min at 140° C. the temperature was increased to 200° C. After 40 min at 200° C. the temperature was cooled to room temperature. The mixture was washed with organic solvents by adding 2 mL of solvent, vortex mixing, centrifugation and decanting off the supernatant. Washing was conducted three times, using tetrahydrofuran in the first and second wash and hexane (mixture of isomers) in the third wash. The remaining solid was heated in vacuum with the following temperature program: heating at 135° C. for 15 min; cooling to room temperature; heating to 200° C.; heating to 650° C. with a heating rate of 5 K/min; holding 650° C. for 3 h; cooling to room temperature. All previous process steps were carried out in inert atmosphere, e.g. argon.

The following steps were conducted in air atmosphere:

The obtained powder was washed three times by adding 4 mL of water, vortex mixing for 10 seconds, ultrasonicating for 1 minute, centrifugation and decanting off the supernatant. The solid was leached with 4 mL of 5.0 molar sulfuric acid at room temperature by ultrasonication for 2 min and stirring for 90 min. The solid was separated by centrifugation and decanting. Leaching with sulfuric acid of the material obtained in the first leaching step was repeated, ultrasonicating for 2 min and stirring for 3 h. Another repetition, using the material obtained after 3 h of stirring was conducted, applying ultrasonication for 2 min and stirring for 16 h. The product was washed twice with H₂O (4 mL): 3 minutes sonication, 3 minutes stir, and then centrifugation. The final product was dried under vacuum for 2 h.

### Example 2

### Pt₃Y

40.9 mg YCl₃, 141.1 mg PtCl₄ and 479 mg KEt₃BH were mixed as powders. 1 mL of 1-octadecene was added and homogenized by stirring. The mixture was stirred and heated to 100° C. for 10 min and cooled to room temperature. The temperature was increased to 130° C. and held for 20 min. The mixture was cooled to room temperature and the solid chunks in the product mixture were broken up mechanically. The temperature was increased to 200° C. under stirring. This temperature was held for 35 min, followed by cooling to room temperature.

The mixture was washed with organic solvents by adding 4 mL of solvent, vortex mixing, centrifugation and decanting off the supernatant. Washing was conducted eight times. Once using a mixture of 1 mL tetrahydrofuran and 3 mL hexane (mixture of isomers), twice with hexane, three times with tetrahydrofuran and twice with hexane.

The remaining solid was heated in vacuum with the following temperature program: heating at 135° C. for 15 min; cooling to room temperature; heating to 200° C.; heating to 650° C. with a heating rate of 5 K/min; holding 650° C. for 3 h; cooling to room temperature.

All previous process steps were carried out in inert atmosphere, e.g. argon.

The following process steps were conducted in air atmosphere.

The obtained powder was leached with 10 mL of 5.0 molar sulfuric acid. This was done under stirring 1 min, followed by ultrasonication for 15 min and stirring for 1 h. The solid was separated by centrifugation and decanting. Leaching with sulfuric acid of the material obtained in the first leaching step was repeated, applying ultrasonication for 15 min and stirring 1 h. Another repetition was conducted, applying ultrasonication 15 min and stirring for 17 h. The product was washed three times with H2O (10 mL): 3 minutes sonication, 3 minutes stir, and then centrifugation. The final product was dried under vacuum for 2 h.

### Example 3

### Pt₃Sc

51 mg ScCl₃, 141.1 mg PtCl₄ and 479 mg KEt₃BH were mixed as powders. 1 mL of 1-octadecene was added and homogenized by stirring. The mixture was stirred and heated to 100° C. for 10 min and cooled to room temperature. The temperature was increased to 130° C. and held for 20 min. The mixture was cooled to room temperature and the solid chunks in the product mixture were broken up mechanically. The temperature was increased to 200° C. under stirring. This temperature was held for 35 min, followed by cooling to room temperature.

The mixture was washed with organic solvents by adding 4 mL of solvent, vortex mixing, centrifugation and decanting off the supernatant. Washing was conducted eight times. Once using a mixture of 1 mL tetrahydrofuran and 3 mL hexane (mixture of isomers), twice with hexane, three times with tetrahydrofuran and twice with hexane.

The remaining solid was heated in vacuum with the following temperature program: heating at 135° C. for 15 min; cooling to room temperature; heating to 200° C.; heating to 650° C. with a heating rate of 5 K/min; holding 650° C. for 3 h; cooling to room temperature.

All previous process steps were carried out in inert atmosphere, e.g. argon.

The following process steps were conducted in air atmosphere.

The obtained powder was leached with 10 mL of 5.0 molar sulfuric acid. This was done under stirring 1 min, followed by ultrasonication for 15 min and stirring for 1 h. The solid was separated by centrifugation and decanting. Leaching with sulfuric acid of the material obtained in the first leaching step was repeated, applying ultrasonication for 15 min and stirring 1 h. Another repetition was conducted, applying ultrasonication 15 min and stirring for 17 h. The product was washed three times with H₂O (10 mL): 3 minutes sonication, 3 minutes stir, and then centrifugation. The final product was dried under vacuum for 2 h.

XRD proved the formation of Pt₃Sc.

### Example 4

### Pt₃Lu

96 mg LuCl₃, 141.1 mg PtCl₄ and 479 mg KEt₃BH were mixed as powders. 1 mL of 1,3-diisopropylbenzene was added and homogenized by stirring. The mixture was stirred and heated to 100° C. for 10 min and cooled to room temperature. The temperature was increased to 130° C. and held for 20 min. The mixture was cooled to room temperature and the solid chunks in the product mixture were broken up mechanically. The temperature was increased to 200° C. under stirring. This temperature was held for 35 min, followed by cooling to room temperature.

The mixture was washed with organic solvents by adding 4 mL of solvent, vortex mixing, centrifugation and decanting off the supernatant. Washing was conducted eight times. Once using a mixture of 1 mL tetrahydrofuran and 3 mL hexane (mixture of isomers), twice with hexane, three times with tetrahydrofuran and twice with hexane.

The remaining solid was heated in vacuum with the following temperature program: heating at 135° C. for 15 min; cooling to room temperature; heating to 200° C.; heating to 650° C. with a heating rate of 5 K/min; holding 650° C. for 3 h; cooling to room temperature.

All previous process steps were carried out in inert atmosphere, e.g. argon.

The following process steps were conducted in air atmosphere.

The obtained powder was leached with 10 mL of 5.0 molar sulfuric acid. This was done under stirring 1 min, followed by ultrasonication for 15 min and stirring for 1 h. The solid was separated by centrifugation and decanting. Leaching with sulfuric acid of the material obtained in the first leaching step was repeated, applying ultrasonication for 15 min and stirring 1 h. Another repetition was conducted, applying ultrasonication 15 min and stirring for 17 h. The product was washed three times with H₂O (10 mL): 3 minutes sonication, 3 minutes stir, and then centrifugation. The final product was dried under vacuum for 2 h.

XRD proved the formation of Pt₃Lu.

### Example 5

### Au₂Y

Applying the conditions of Example 2 using AuCl₃ instead of PtCl₄, the intermetallic phase Au₂Y was formed. The formation of Au₂Y was determined by XRD.

Analysis of the Obtained Products

The powders obtained in example 1 and example 2 were analyzed by transmission electron microscopy (TEM) and x-ray diffraction (XRD). The results are shown in the accompanying figures.

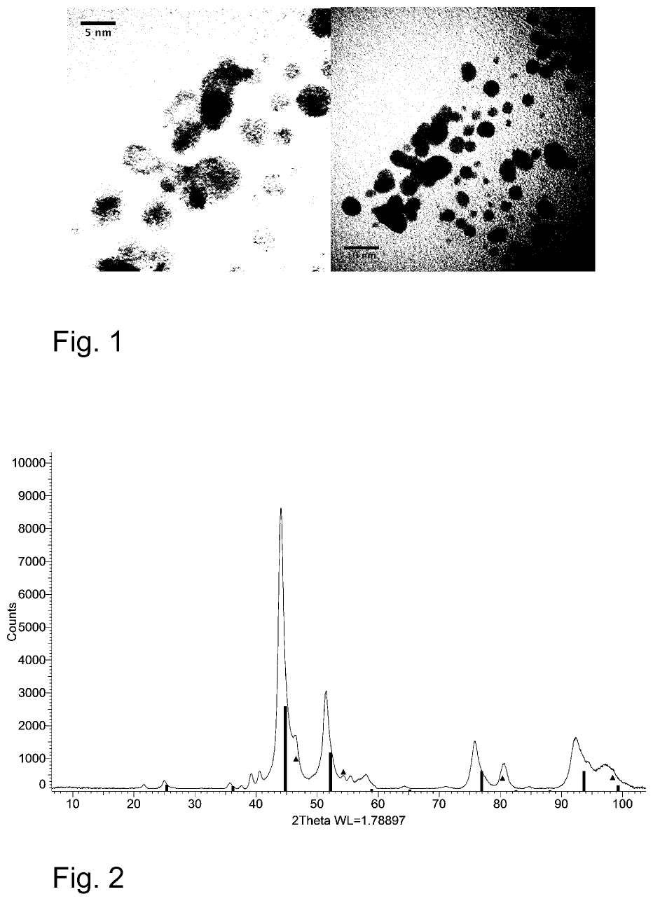

FIG. 1 shows a TEM picture of the powder obtained in example 1,

FIG. 2 shows an XRD pattern of the powder obtained in example 1,

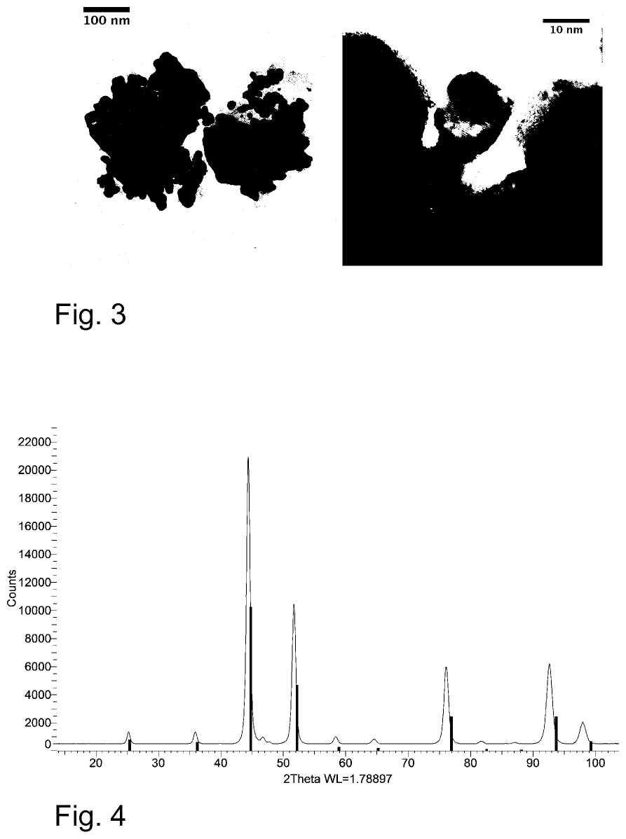

FIG. 3 shows a TEM picture of the powder obtained in example 2,

FIG. 4 shows an XRD pattern of the powder obtained in example 2.

TEM and electron diffraction were performed on a LaB₆ FEI Tecnai G2 20 TEM operating at 200 kV. TEM samples were prepared by placing a drop of the particle solution onto a carbon-coated copper grid.

XRD was performed on a Bruker D8 GADDS diffractometer with a cobalt source (Kα1=1.79 Å). When necessary, XRD samples were dropcast onto a flat plastic holder.

As can be seen in FIG. 1, in the obtained final product of example 1 nanoparticles are present. The obtained final product of example 2 also is present in nanoparticles, however, as can be seen in FIG. 3, the nanoparticles are agglomerated.

The XRD spectrograph in FIG. 2 of the product obtained in example 1 shows the presence of Pt₃Y as main phase and minor amounts of Pt.

In example 2 an intermetallic compound Pt₃Y with high purity was obtained as can be seen in the XRD spectrograph in FIG. 4.

In FIGS. 2 and 4 the bars represent library data of Pt₃Y. In FIG. 2 the triangular dots represent the library data of platinum.

In the XRD spectrographs the reflexes that are assigned to Pt₃Y are shifted towards lower angles in comparison to library data, corresponding to higher lattice constants. These observations can be explained by interstitial hydrides as observed for La—Ni systems as described by Lynch, J. F.; Reilly, J. J., J. Less-Common Metals, 1982 87, pages 225-236.

1. A process for producing a catalyst comprising an intermetallic compound, the process comprising following steps:
(a) Mixing of a salt comprising a metal selected from the group consisting of Co, Rh, Ir, Ni, Pd, Pt, Cu, Ag, Au and Ru, a salt comprising a metal selected from the group consisting of Li, Na, K, Rb, Cs, Be, Mg, Ca, Sr, Ba, Sc, Y, La and the lanthanides, and a reducing agent comprising a salt, wherein the mixing is carried out at a temperature where all components are solid;
(b) Reacting the mixture obtained in step (a) to form an intermetallic compound by heating said mixture to a temperature in the range between the melting temperature of the reducing agent and the melting temperature of the intermetallic compound and holding the temperature for 1 minute to 600 minutes;
(c) Optionally, washing the mixture obtained in step (b) once or repeatedly with one or more aprotic solvents or combinations of aprotic solvents, whereby a salt of the cation of the reducing agent and at least one of the anions of the salts used in step (a) does not dissolve in said solvent, followed by heating the mixture obtained after washing to a temperature in the range between the melting temperature of the reducing agent and the melting temperature of the intermetallic compound and holding the temperature for 1 minute to 600 minutes, wherein the washing and heating can be carried out repeatedly; and
(d) Washing the mixture obtained in step (b) or (c) to remove by-products and remainders of the salt of the cations of the reducing agent and at least one of the anions of the salts used in step (a).

2. The process according to claim 1, wherein a support is added in step (a) or during the washing in step (c) or in step (d) to achieve a supported catalyst comprising the support and the intermetallic compound, wherein the intermetallic compound is in the form of nanoparticles and deposited on the surface of the support and in the pores of the support.

3. The process according to claim 1, wherein an aprotic liquid is added to the solid components in step (a) as a plasticizer or stirring aid, the aprotic liquid being selected from the group consisting of alkanes, alkenes, aromatic hydrocarbons, amines, ethers and mixtures thereof, provided that each of said components is liquid at 50° C.

4. The process according to claim 3, wherein the aprotic liquid added in step (a) is selected from the group consisting of squalane, 1,13-tetradecadiene, 1-octadecene, trioctlyamine, 1,3-diisopropylbenzene and dioctyl ether.

5. The process according to claim 1, wherein in step (a) additionally an inert salt is added.

6. The process according to claim 5, wherein the inert salt is an alkali metal halide.

7. The process according to claim 1, wherein step (a), step (b) and the heating in step (c) are carried out in an inert atmosphere.

8. The process according to claim 1, wherein the salt comprising a metal selected from the group consisting of Co, Rh, Ir, Ni, Pd, Pt, Cu, Ag, Au and Ru is a platinum salt, a silver salt, a rhodium salt, an iridium salt, a palladium salt or a gold salt.

9. The process according to claim 1, wherein the salt comprising a metal selected from the group consisting of Li, Na, K, Rb, Cs, Be, Mg, Ca, Sr, Ba, Sc, Y, La and the lanthanides is a calcium salt, an yttrium salt, a scandium salt or a lanthanum salt.

10. The process according to claim 1, wherein the salt comprising a metal selected from the group consisting of Co, Rh, Ir, Ni, Pd, Pt, Cu, Ag, Au and Ru is a halide.

11. The process according to claim 1, wherein the salt comprising a metal selected from the group consisting of Li, Na, K, Rb, Cs, Be, Mg, Ca, Sr, Ba, Sc, Y, La and the lanthanides is a halide.

12. The process according to claim 10, wherein the halide is a chloride.

13. The process according to claim 1, wherein the reducing agent is an alkali metal alkylborohydride or an alkali metal arylborohydride or a mixture of an alkali metal hydride with an alkylborane or an arylborane.

14. The process according to claim 1, wherein the reducing agent is selected from the group consisting of alkali metal triethylborohydride, alkali metal tripropylborohydride, alkali metal tributylborohydride, alkali metal hydride with triethylborane, alkali metal hydride with tripropylborane, and alkali metal hydride with tributylborane.

15. The process according to claim 14, wherein the alkali metal of the reducing agent is potassium or sodium.

16. The process according to claim 1, wherein the aprotic solvent which is used for washing in step (c) is selected from the group consisting of tetrahydrofuran, dioxanes, ethylene glycol dimethyl ether and diethylene glycol dimethyl ether either alone or in conjunction with a low-boiling alkane from the group consisting of pentane, hexane, and heptane.

17. The process according to claim 1, wherein the washing in step (d) is carried out with water or an aqueous solution of an acid.

18. A catalyst produced by the process according to claim 1, wherein the catalyst comprises a support and an intermetallic compound comprising a metal selected from the group consisting of Co, Rh, Ir, Ni, Pd, Pt, Cu, Ag, Au and Ru, and a metal selected from the group consisting of Li, Na, K, Rb, Cs, Be, Mg, Ca, Sr, Ba, Sc, Y, La, and lanthanides, wherein the intermetallic compound is in the form of nanoparticles and is deposited on the surface of the support and in macropores, mesopores and micropores of the support.

19. The catalyst according to claim 18, wherein the intermetallic compound comprises platinum and one of Ca, Y, Sc and La.

20. The catalyst according to claim 18, wherein the support is a porous support having a BET surface of at least 4 m2/g.

21. The catalyst according to claim 18, wherein the support is a metal oxide or carbon.

22. The catalyst according to claim 18, wherein the support is selected from the group consisting of carbon black, activated carbon, graphenes and graphite.

23. The catalyst according to claim 18, wherein the intermetallic compound is Pt2Ca, Pt3Y, Pt3Sc or Pt3La.

24. The process according to claim 11, wherein the halide is a chloride.
